(19) United States
(12) Patent Application Publication
(10) Pub. No.: US 2004/0227941 A1
(43) Pub. Date: Nov. 18, 2004

(54) Particle size distribution analyzer

(76) Inventors: Tetsuji Yamaguchi, Kyoto (JP); Juichiro Ukon, Kyoto (JP); Makoto Umezawa, Kyoto (JP)

Correspondence Address: SNELL & WILMER L.L.P., Suite 1200, 1920 Main Street, Irvine, CA, 92614-7230, US

(21) Appl. No.: 10/782,293

(22) Filed: Feb. 19, 2004

(30) Foreign Application Priority Data
Feb. 27, 2003 (JP) P2003-050200

(51) Int. Cl. G01N 15/02

(52) U.S. Cl. 356/336

(57) ABSTRACT

A particle size distribution analyzer is provided which is capable of analysis with improved precision by canceling noise superimposed on scattering light information obtained from a test sample containing test particles to be analyzed. The particle size distribution analyzer includes: a fundamental light guide mechanism (5) operative to divide fundamental light (L) irradiated from a single light source and then guide divided fundamental lights (La and Lb) to the reference sample (RS) used as a reference and the test sample (OS), respectively; a scattering light guide mechanism (7) for guiding scattering lights (LNa and LNb) caused by irradiation of the samples (RS and OS) with the respective divided fundamental lights (La and Lb) to a light intensity detecting section (6) configured to detect the intensity of light; and an information processing section (8) for calculating a particle size distribution of the group of test particles contained in the test sample (OS) based either on a difference between fluctuations of the intensities of the respective scattering lights (LNa and LNb) detected by the light intensity detecting section (6) or on a difference between information items computed from the respective fluctuations.

### BACKGROUND OF THE INVENTION

1. Field of the Invention

The present invention relates to a particle size distribution analyzer which measures scattering light caused by irradiating a group of dispersed particles with fundamental light and then calculates the particle size distribution of the group of dispersed particles based on information on the measurement.

2. Description of the Related Art

The optical system of the conventional so-called “dynamic light scattering particle size distribution analyzer” includes a fundamental light guide mechanism for guiding fundamental light irradiated from a light source to a sample containing test particles, and a scattering light guide mechanism for guiding scattering light from the sample to a photodetector.

Since this type of analyzer calculates the particle size distribution of a group of dispersed particles by utilizing the phenomenon that the intensity of scattering light caused by irradiating the group of dispersed particles with fundamental light having a certain frequency fluctuates with time due to Brownian motion of those particles as described in Japanese Patent Laid-Open Publication No. 2002-221479, noise can be caused by such influence as exerted by vibration of the analyzer-installed site, by scattering due to a difference in refractive index at an interface or by scattering at scraches on a cell surface and the like. It is possible that such noise is mixed with measured data to lower the precision of analysis.

In attempt to cancel such noise, it is conceivable that only a true signal component is extracted by deducting the result of measurement on a sample composed only of a solvent not containing particles from the result of measurement on a sample composed of a solvent containing the particles.

However, since this type of conventional analyzer has only one cell for containing a sample, measurement on those two types of sample requires a considerably long time in replacing one sample with the other. In addition, an environmental change occurs due to a measurement time lag, which makes it impossible to realize desired noise canceling.

Accordingly, it is a main object of the present invention to provide a particle size distribution analyzer which is capable of measuring a reference sample used as a reference and a test sample to be analyzed in substantially the same environment and in substantially the same time zone thereby realizing effective noise canceling based on the difference between the result of measurement obtained from the reference sample and that obtained from the test sample.

### SUMMARY OF THE INVENTION

In order to accomplish the aforementioned object, the present invention provides a particle size distribution analyzer for analyzing a particle size distribution of a group of particles contained in a sample based on a fluctuation of scattering light caused by irradiating the sample with fundamental light, the particle size distribution analyzer including: a reference cell for containing a reference sample used as a reference; a test cell for containing a test sample composed of the reference sample and a group of test particles added thereto; a fundamental light guide mechanism operative to divide fundamental light irradiated from a single light source for irradiating the reference sample and the test sample with respective divided fundamental lights; a light intensity detecting section operative to receive scattering lights from the respective samples for detecting the intensities of the respective scattering lights; and an information processing section for calculating a particle size distribution of the group of test particles contained in the test sample based either on a difference between fluctuations of the intensities of the respective scattering lights detected by the light intensity detecting section or on a difference between information items computed from the respective fluctuations.

With such a construction, it is possible to place the reference cell and the sample cell in the same analyzer as well as to measure scattering lights from those samples in substantially the same time zone. Therefore, disturbing influence from the same factor arising during measurement, namely noise, is superimposed substantially equally on the measurement results obtained from the respective two scattering lights. Accordingly, by deduction of one result from the other, the noise can be cancelled effectively and, hence, only scattering light information on the group of test particles can be extracted. This makes it possible to improve the precision of particle size distribution analysis remarkably. Even when influence of vibration for example occurs during analysis, noise caused thereby is superimposed on both of the measurement results obtained from the reference sample and the test sample. For this reason, it is possible to obtain true information which is completely free of the influence of noise by deducting one result from the other. The expression “to divide fundamental light” is meant to include: dividing fundamental light spatially to form two optical paths along which divided lights travel simultaneously; and dividing fundamental light on a time basis to form an optical path for guiding the fundamental light to either of the samples selectively. The term “information items computed from respective fluctuations” is meant to include intermediate computed information, for example, information on a frequency distribution on intensity computed from fluctuation.

In a preferred embodiment, the reference sample is composed only of a predetermined solvent, while the test sample contains the test particles dispersed in the predetermined solvent.

To make perfectly simultaneous measurements possible, the analyzer preferably has an arrangement wherein the fundamental light guide mechanism is composed of constituent elements including optical components, all the constituent elements being fixed, a light dividing element of the constituent elements being operative to divide the fundamental light spatially. Preferred examples of such light dividing elements, which are relatively inexpensive, include a half mirror and a pair of knife-edge mirrors to be disposed on the optical path of the fundamental light.

If the analyzer has an arrangement wherein the fundamental light guide mechanism is composed of constituent elements including optical components, some of the constituent elements being movable, and is operative to divide the fundamental light on a time basis by moving the movable elements, substantially the same effect as described above can be obtained.

To put the samples in more approximated environments for effective elimination of noise, the cells are desirably formed integral with each other.

The fundamental light guide mechanism is not limited to that which is operative to divide the fundamental light. If, for example, the reference sample is composed only of a solvent, the fundamental light irradiant on the reference sample mostly passes through the reference sample. For this reason, the fundamental light guide mechanism may be configured to further guide the fundamental light having passed through the reference sample to the test sample. Such a configuration makes it possible to simplify the structure of the analyzer and realize a cost reduction.

Another embodiment of the particle size distribution analyzer has an arrangement wherein a pair of light sources are provided and the fundamental light guide mechanism is operative to guide one of fundamental lights irradiated from the pair of light sources to a reference sample used as a reference and the other to a test sample to be analyzed.

On the other hand, an embodiment of the scattering light detecting side has an arrangement wherein a pair of light intensity detecting sections are provided and the scattering light guide mechanism is operative to guide scattering lights to the respective light intensity detecting sections.

Of course, it is possible to employ an arrangement wherein a single light intensity detecting section is provided and the scattering light guide mechanism is operative to switch from one of scattering lights from the respective samples to the other for selectively guiding either of the scattering lights to the light intensity detecting section.

Another arrangement is possible such as to selectively irradiate either of the cells with fundamental light by moving the cells instead of dividing the fundamental light. Such an arrangement can use a single light intensity detecting section and a single scattering light guide mechanism and hence is practically applicable to the so-called light scattering/diffraction particle size distribution analyzer for analyzing a particle size distribution based on an angle distribution of scattering light intensity.

It should be noted that the term “information item related to the intensity of scattering light”, as used in claim 12, is meant to include not only an information item directly indicative of the intensity of scattering light but also an information item related to the scattering light intensity, for example, an information item obtained by computation.

The foregoing and other objects, features and attendant advantages of the present invention will become apparent from the reading of the following detailed description in conjunction with the accompanying drawings.

### BRIEF DESCRIPTION OF THE DRAWINGS

FIG. 1 is a schematic overview of a dynamic light scattering particle size distribution analyzer according to one embodiment of the present invention;

FIG. 2 is a flowchart of operational steps of the dynamic light scattering particle size distribution analyzer according to the same embodiment;

FIG. 3 is a schematic overview of a dynamic light scattering particle size distribution analyzer according to another embodiment of the present invention;

FIG. 4 is a schematic overview of a dynamic light scattering particle size distribution analyzer according to another embodiment of the present invention;

FIG. 5 is a schematic overview of a dynamic light scattering particle size distribution analyzer according to yet another embodiment of the present invention;

FIG. 6 is a schematic view illustrating a variation of fundamental light guide means according to the present invention;

FIG. 7 is a schematic view illustrating a variation of fundamental light guide means according to the present invention;

FIG. 8 is a schematic view illustrating a variation of fundamental light guide means according to the present invention;

FIG. 9 is a schematic view illustrating a variation of fundamental light guide means according to the present invention;

FIG. 10 is a schematic view illustrating a variation of fundamental light guide means according to the present invention;

FIG. 11 is a schematic view illustrating a variation of fundamental light guide means according to the present invention;

FIG. 12 is a schematic view illustrating a variation of fundamental light guide means according to the present invention;

FIG. 13 is a schematic view illustrating a variation of fundamental light guide means according to the present invention;

FIG. 14 is a schematic view illustrating a variation of fundamental light guide means according to the present invention;

FIG. 15 is a schematic view illustrating a variation of fundamental light guide means according to the present invention;

FIG. 16 is a schematic view illustrating a variation of fundamental light guide means according to the present invention;

FIG. 17 is a schematic view illustrating a variation of fundamental light guide means according to the present invention;

FIG. 18 is a schematic view illustrating a variation of fundamental light guide means according to the present invention;

FIG. 19 is a schematic view illustrating a variation of cells according to the present invention;

FIG. 20 is a schematic view illustrating a variation of cells according to the present invention;

FIG. 21 is a schematic view illustrating a variation of fundamental light guide means according to the present invention; and

FIG. 22 is a schematic view illustrating a variation of fundamental light guide means according to the present invention.

### DETAILED DESCRIPTION OF THE PREFERRED EMBODIMENTS

Hereinafter, one embodiment of the present invention will be described in detail with reference to the accompanying drawings.

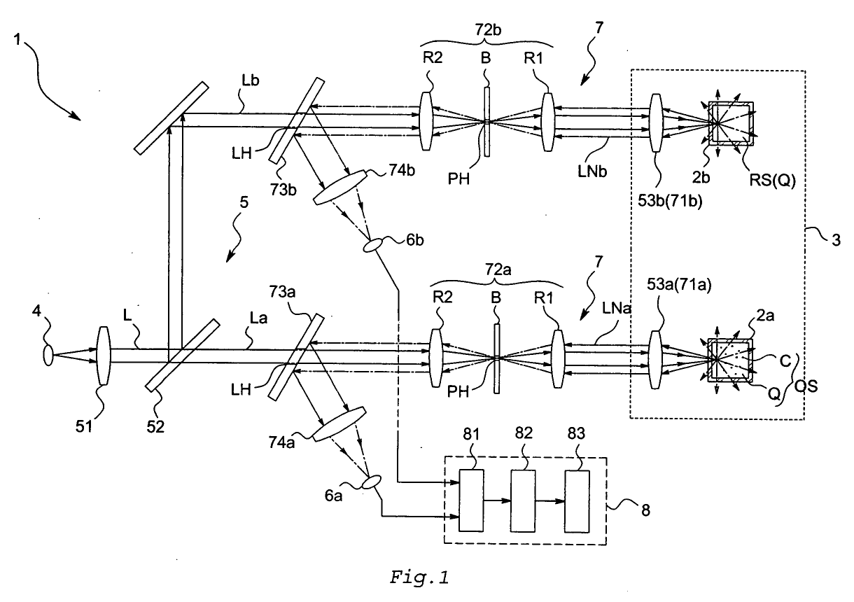

FIG. 1 is a schematic overview of a particle size distribution analyzer 1 according to this embodiment. The particle size analyzer 1 shown is of the dynamic light scattering type and includes a transparent test cell 2a for containing a test sample OS containing test particles C to be analyzed which are dispersed in a solvent Q, a transparent reference cell 2b for containing a reference sample RS composed only of the solvent Q, a cell unit 3 holding the cells 2a and 2b therein, a single light source (a semiconductor laser) 4, a fundamental light guide mechanism 5 operative to spatially divide laser light L irradiated as fundamental light from the semiconductor laser 4 and then guide divided laser lights L to the reference sample RS and the test sample OS, respectively, from the outsides of the cells 2a and 2b, a light intensity detecting section (photodetector) 6 for detecting the intensity of light, a scattering light guide mechanism 7 for guiding scattering lights LNa and LNb from the respective samples OS and RS to photodetectors 6a and 6b, and an information processing section 8 for calculating the particle size distribution of the group of test particles C contained in the test sample OS based on the difference between fluctuations of the intensities of the respective scattering lights LNa and LNb detected by the photodetectors 6a and 6b.

Description will be made of each part of the analyzer 1.

The test cell 2a and the reference cell 2b are hollow transparent glass members which are identical with each other and are accommodated in the cell unit 3. Since Brownian motions of the test particles C vary sensitively with change in temperature, which may affect the measurement, this embodiment is provided with a temperature control mechanism (not shown) for controlling the temperature within the cell unit 3 to stabilize the temperatures of the respective samples under measurement, thereby ensuring high-precision measurement.

The fundamental light guide mechanism 5 includes a collimator lens 51 for turning diffused laser light L irradiated from the semiconductor laser 4 into a beam of parallel laser light having a certain diameter, a half mirror 52 as a light dividing element for spatially dividing the parallel laser light L into passing light La and reflected light Lb, a condenser lens 53a for the test sample OS for condensing the first laser light La having passed through the half mirror 52 in a region located slightly inwardly of an inside surface of the test cell 2a, and a condenser lens 53b for the reference cell RS for condensing the second laser light Lb reflected by the half mirror 52 in a region located slightly inwardly of an inside surface of the reference cell 2b.

Each of the photodetectors 6a and 6b is adapted to receive light of a predetermined wave range and then output a light intensity signal which is an electrical signal having a strength corresponding to the intensity of light received, as is well known. This embodiment is provided with two photodetectors 6a and 6b for the test sample OS and the reference sample RS, respectively.

The scattering light guide mechanism 7 is used in measurement of back scattering light for example and includes pairs of constituent elements for guiding scattering lights LNa and LNb, which are caused by irradiation of the samples OS and Rs with laser lights La and Lb, respectively, to the respective photodetectors 6a and 6b. Such constituent elements include paralleling lens 71a and 71b for turning scattering lights LNa and LNb, which are scattered in directions opposite to the traveling directions of irradiant laser lights La and Lb, into parallel lights having larger diameters than the aforementioned parallel laser lights La and Lb, noise light cutoff portions 72a and 72b for cutting off noise-causing light such as multiple scattering light from the paralleled scattering lights LNa and LNb, reflecting mirrors 73a and 73b for reflecting the scattering lights LNa and LNb outgoing from the respective noise light cutoff portions 72a and 72b to change their respective optical paths, and condenser lenses 74a and 74b for condensing the scattering lights LNa and LNb onto the light-receiving surfaces of the respective photodectors 6a and 6b. The paralleling lenses 71a and 71b also serve as the condenser lenses 53a and 53b in the fundamental light guide mechanism 5, so that the optical paths of the scattering lights LNa and LNb coincide with the optical paths of the corresponding irradiant laser lights La and Lb up to some midpoints. The noise cutoff portions 72a and 72b each include a shielding plate B having a pinhole PH, and a pair of convex lenses R1 and R2 positioned on opposite sides of the shielding plate B. Since the reflecting mirrors 73a and 73b are disposed on the optical paths of the parallel laser lights La and Lb, each of the reflecting mirrors 73a and 73b centrally defines a laser light passing hole LH having a diameter generally equal to the diameter of the corresponding parallel laser light La or Lb so as to allow the laser light to pass therethrough without varying the amount of parallel laser light La or Lb. According to this embodiment, the semiconductor laser 4, cells 2a and 2b, cell unit 3, fundamental light guide mechanism 5, scattering light guide mechanism 7, photodetectors 6a and 6b and so forth are accommodated in the same enclosure.

The information processing section 8 exercises its functions by the operations of a CPU and peripheral hardware based on the program stored in a storage unit and the operation of a discrete circuit exclusive to this section. The information processing section 8 functions as a differential section 81 operative to receive fluctuation information items indicative of respective time-based fluctuations of scattering light intensity signals outputted from the respective photodetectors 6a and 6b for finding the difference between these information items, a calculating section 82 for calculating a particle size distribution using parameters including difference information generated by the differential section 81 as well as data on the refractive index, temperature, viscosity and the like related to the solvent and the particles, an outputting section 83 for outputting the result of calculation in a predetermined form to a display, a printer or the like. It should be noted that since this embodiment employs a homodyne detection method and since the details of calculation performed in this embodiment such as the algorithm used in the calculation of a particle size distribution based on the aforementioned parameters have been disclosed in Japanese Patent Laid-Open Publication No. 2000-171383 and the like by the inventors of the present invention, description thereof is herein omitted. It is needless to say that the present invention may employ a heterodyne detection method. While this embodiment is configured such that the differential section 81 finds the difference between scattering light intensity signals remaining in analog signal form by means of the discrete differential circuit and the result is converted into digital form and then transmitted to the calculating section 82, it is possible to employ a configuration such as to find the difference between scattering light intensity signals after conversion of these signals into digital signals.

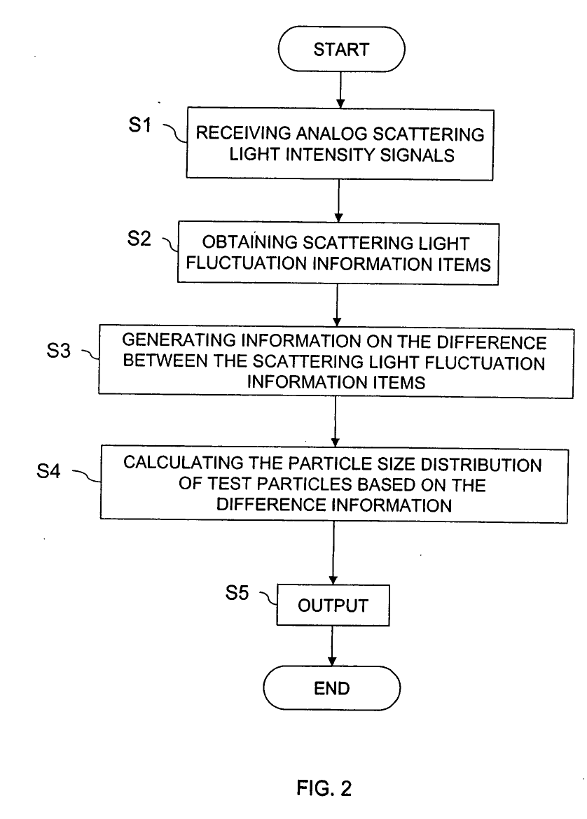

Next, an example of the operation of the particle size distribution analyzer 1 will be described with reference to FIG. 2.

When laser light L is irradiated from the semiconductor laser 4, the half mirror 52 divides the laser light L into two laser lights La and Lb having equal intensity, which in turn irradiate the test sample OS in the test cell 2a and the reference sample RS in the reference cell 2b, respectively. Subsequently, the scattering light guide mechanism 7 causes scattering lights LNa and LNb occurring at the respective cells 2a and 2b to be received by the respective photodetectors 6a and 6b, which in turn output analog scattering light intensity signals corresponding to the respective lights LNa and LNb.

In turn, the information processing section 8 receives the analog scattering light intensity signals (step S1) to obtain reference scattering light fluctuation information and test sample scattering light fluctuation information, which are time-based fluctuation information items (step S2).

Then, the information processing section 8 finds the difference between the scattering light fluctuation information items obtained at step S2 to generate difference information (step S3).

Subsequently, the information processing section 8 calculates the particle size distribution of the group of test particles contained in the test sample based on the difference information generated at step S3 (step S4) and then outputs the result of calculation in a predetermined form to the display, the printer or the like (step S5).

Meanwhile, since the reference sample RS is composed only of the solvent Q, fluctuation information obtained therefrom is considered to be noise caused by disturbance such as influence exerted by vibration of the analyzer-installed site, influence exerted by scattering due to a difference in refractive index at an interface, or like influence.

Since the test cell 2a and reference cell 2b are held within the same cell unit 3 and hence kept in substantially the same ambient environments and since measurements of scattering lights LNa and LNb from these cells 2a and 2b are conducted perfectly simultaneously, the fluctuation information item obtained from the test sample OS is considered to include true information on fluctuation due to Brownian motions of the test particles C and noise superimposed on the true fluctuation information, the noise being equal to the noise obtained from the reference sample RS.

Since this embodiment deducts the fluctuation information item obtained from the reference sample RS, namely noise, from the fluctuation information item obtained from the test sample OS, this embodiment is capable of obtaining true fluctuation information in which noise has been effectively cancelled, thereby remarkably improving the precision of analysis as compared to that of the conventional analyzer.

The present invention is not limited to the above-described embodiment. Like reference characters designate like or corresponding parts throughout the foregoing embodiment and the embodiments shown in the figures to be mentioned below. Some of the structures shown in those figures are illustrated as a simplified fashion.

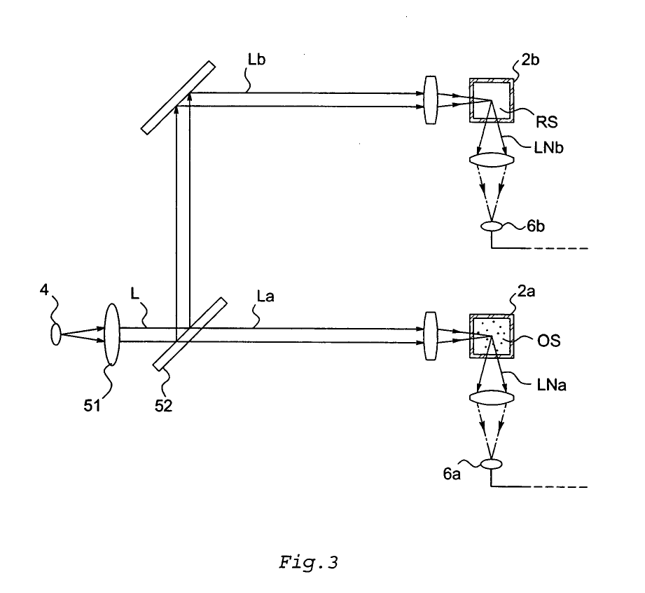

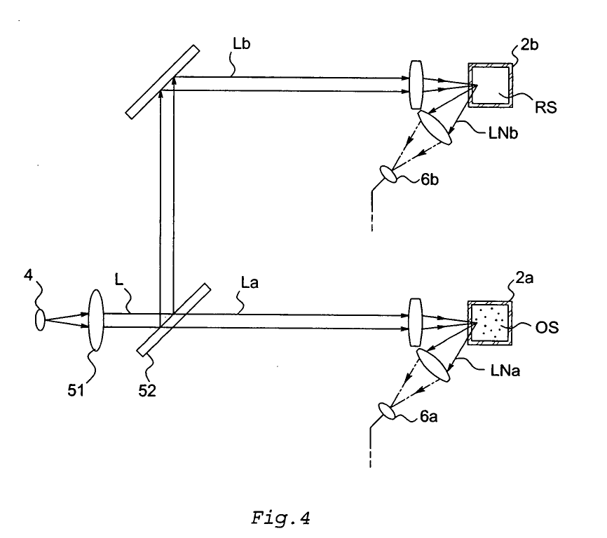

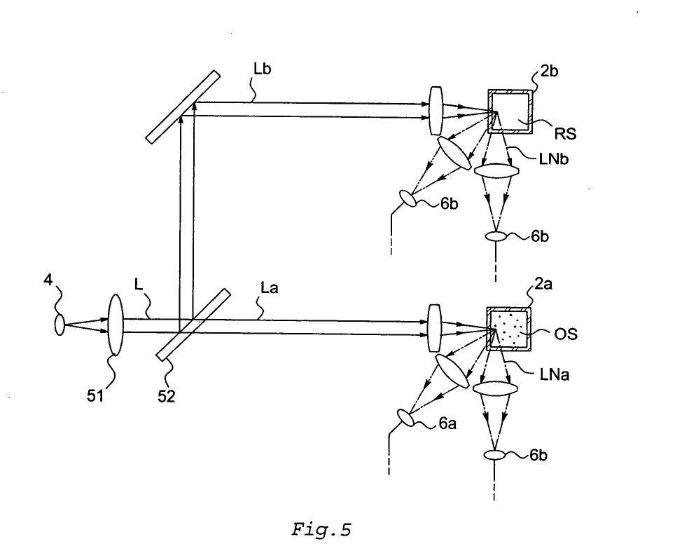

For example, the scattering light guide mechanism may be configured to allow detection of not only back scattering lights as in the foregoing embodiment but also scattering lights LNa and LNb each traveling in a lateral direction (90° direction for example) or in a back slanting direction (170° direction for example) as shown in FIGS. 3 and 4. Alternatively, the scattering light guide mechanism may be configured to allow detection of scattering lights LNa and LNb at different angles. This is because the intensity of each of the scattering lights LNa and LNb has angle dependence due to the relationship between the wavelength of laser light L and the particle sizes of test particles C. Though not shown, it is possible to employ an arrangement wherein only one photodetector is provided and the scattering light guide mechanism is configured to selectively guide either of scattering lights from the respective samples to the single photodetector.

Also, various embodiments of the fundamental light guide mechanism are conceivable. Brief description will be made of examples of the fundamental light guide mechanism in which all its constituent elements including optical components are fixed and a light dividing element of these constituent elements is operative to divide fundamental light spatially.

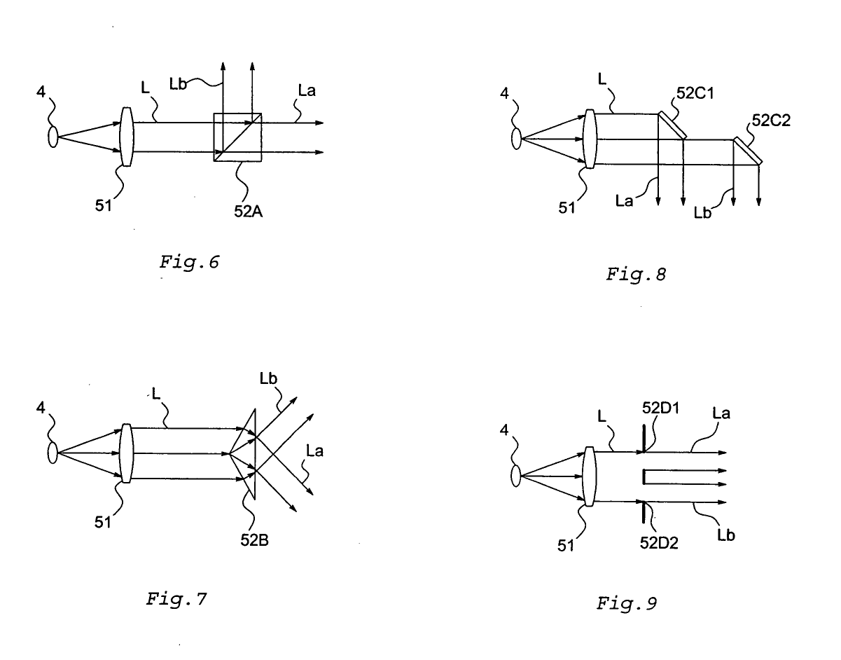

While the foregoing embodiment utilizes the half mirror as the light dividing element, the fundamental light guide mechanism may utilize a beam splitter 52A (FIG. 6), biprism 52B (FIG. 7), a pair of knife-edge mirrors 52C1 and 52C2 (FIG. 8), a pair of slits 52D1 and 52D2 (FIG. 9), or the like instead of the half mirror. These examples enable perfectly simultaneous measurement of scattering lights from the respective samples.

Alternatively, the analyzer may have an arrangement wherein the fundamental light guide mechanism is composed of constituent elements, some of which are movable, for guiding fundamental light to either of the samples selectively by moving the movable elements.

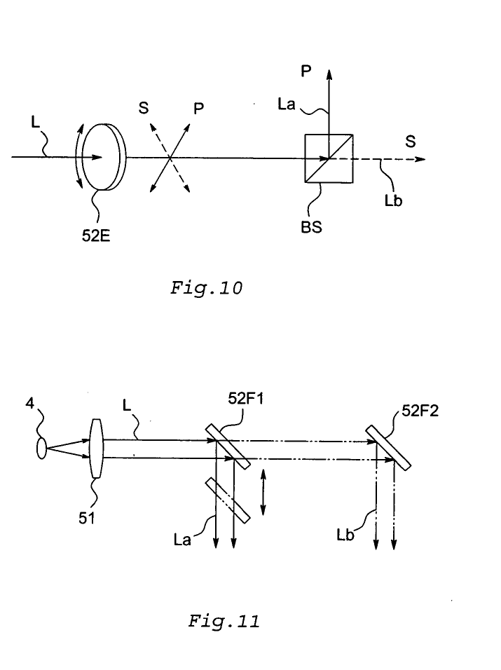

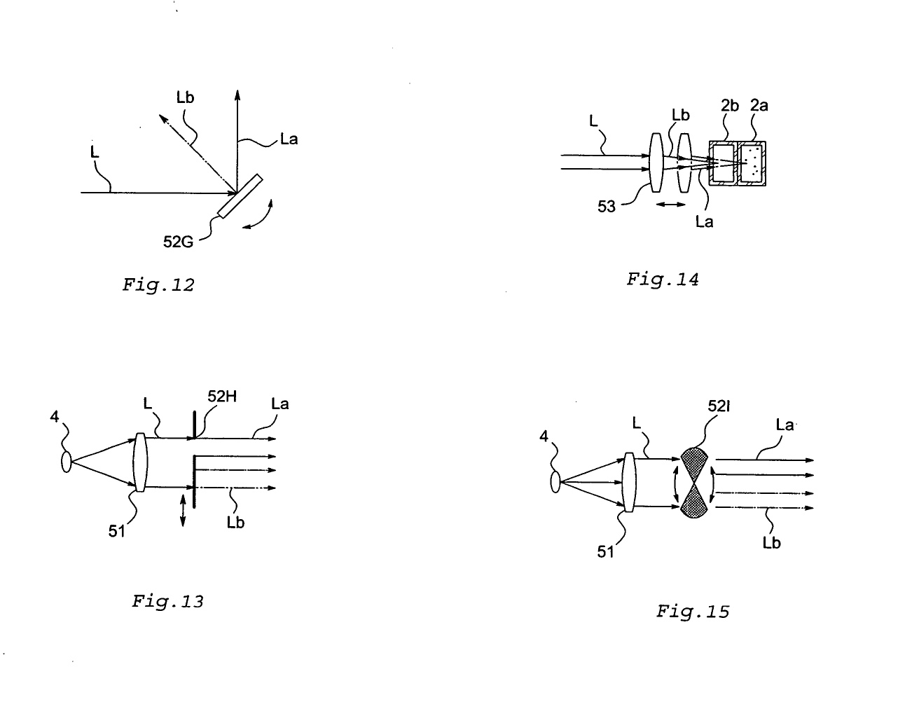

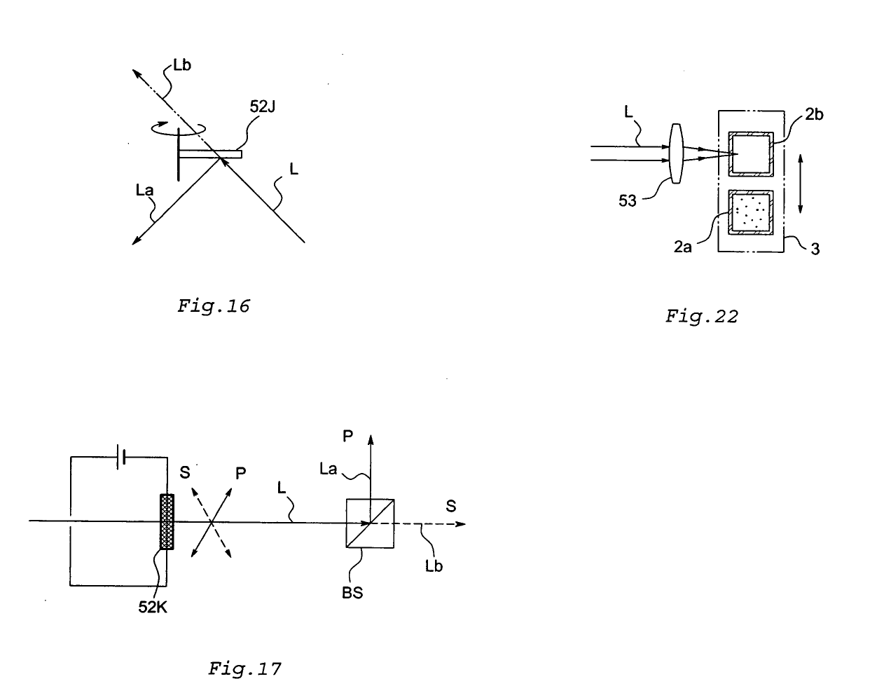

One example of such an arrangement utilizes a ½ wave plate 52E as a movable element (FIG. 10). This arrangement selectively changes the polarizing direction P or S by rotating the wave plate 52E and selectively irradiates either of the samples with laser light La or Lb in accordance with the polarizing direction by means of a polarization beam splitter BS disposed behind the wave plate 52E. Other examples include: an arrangement utilizing a pair mirrors 52F1 and 52F2 disposed serially on the optical path of laser light, that mirror is located upstream being movable from the optical path (FIG. 11); an arrangement utilizing a mirror 52G rotatably supported for selectively irradiating either of the samples with fundamental light in accordance with the angle through which the mirror 52 rotates (FIG. 12); an arrangement utilizing a single slit 52H which is made movable (FIG. 13); an arrangement wherein the reference cell 2b and the sample cell 2a are disposed serially on the optical axis of irradiant laser light and laser light can be selectively focused on either of the reference sample 2b and the test sample 2a by moving a condenser lens 53 along the optical axis or varying the focal length of the condenser lens 53 (FIG. 14); an arrangement utilizing a chopper 52I (FIG. 15); and an arrangement utilizing a sector mirror 52J (FIG. 16). Another possible arrangement utilizes an optical polarizing element 52K instead of the ½ wave plate as shown in FIG. 12, though the optical polarizing element is not a movable element. Since these arrangements cannot perform perfectly simultaneous measurement of scattering lights from the respective samples but are capable of sequential measurement or repeated measurement, they can exercise substantially the same effect as exercised by the foregoing embodiment. In these cases it is difficult to find the difference between fluctuation information items which are time sequence data items because each of those arrangements measures fluctuations of respective scattering lights not simultaneously in the strict sense. For this reason, it is desirable that the information processing section be configured to find the difference between fluctuation-related information items which are calculated from the respective fluctuation information items without using time as a parameter, for example, information on a frequency distribution on intensity.

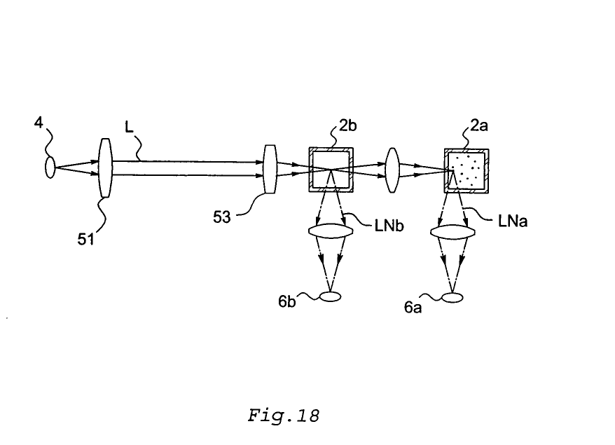

Yet another possible arrangement is such that the fundamental light guide mechanism is operative to guide laser light L irradiated from the semiconductor laser to the reference sample RS and then further guide the laser light L having passed through the reference sample RS to the test sample OS, as shown in FIG. 18.

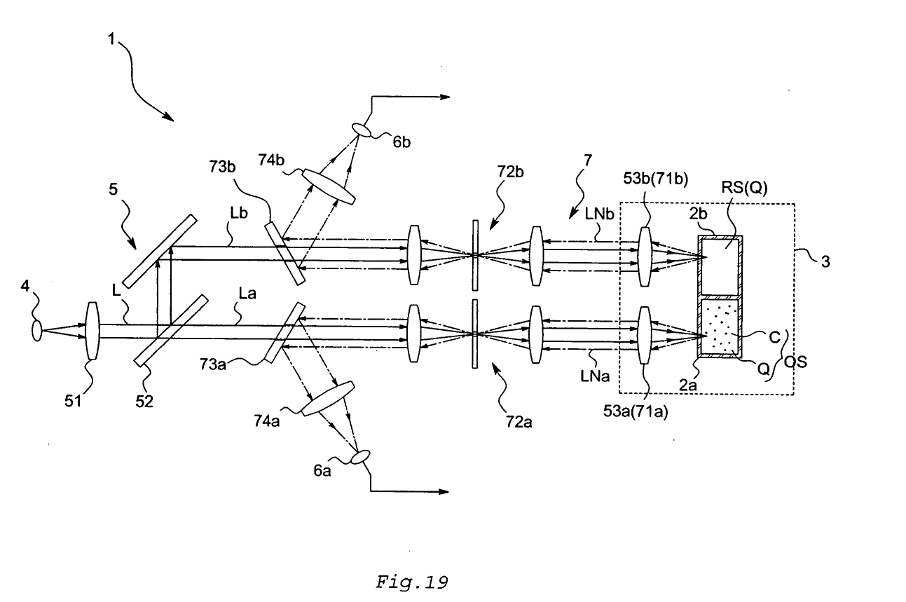

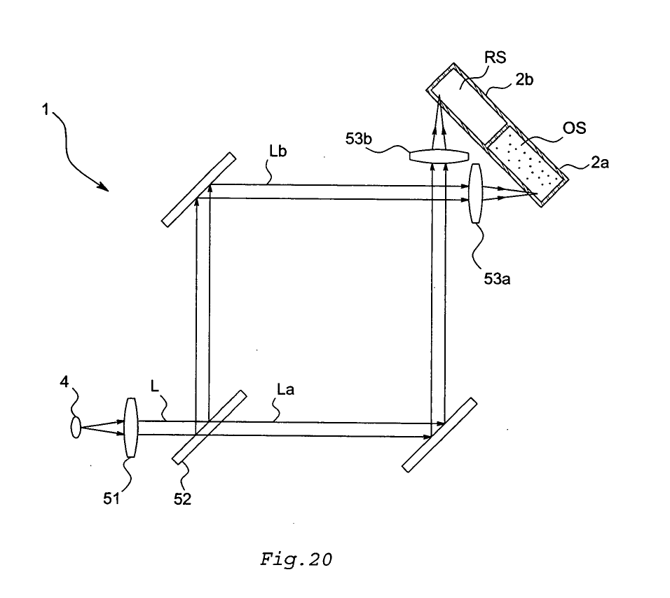

With respect to the cells, the reference cell 2b and the test cell 2a may be formed integral with each other, as shown in FIG. 19. In the structure shown in FIG. 19, a single transparent casing is centrally partitioned into two cells with a partition wall, one for use as the reference cell 2b, the other as the test cell 2a. In this case it is possible to employ an arrangement such as to irradiate the front wall surfaces of the respective cells 2a and 2b with laser lights La and Lb perpendicularly as shown in FIG. 19 or an arrangement such as to guide divided laser lights La and Lb in directions perpendicularly intersecting each other and then irradiate the front wall surfaces of the respective cells 2a and 2b with the laser lights La and Lb obliquely at a certain angle. Such oblique irradiation can also enjoy the advantage of reducing noise light.

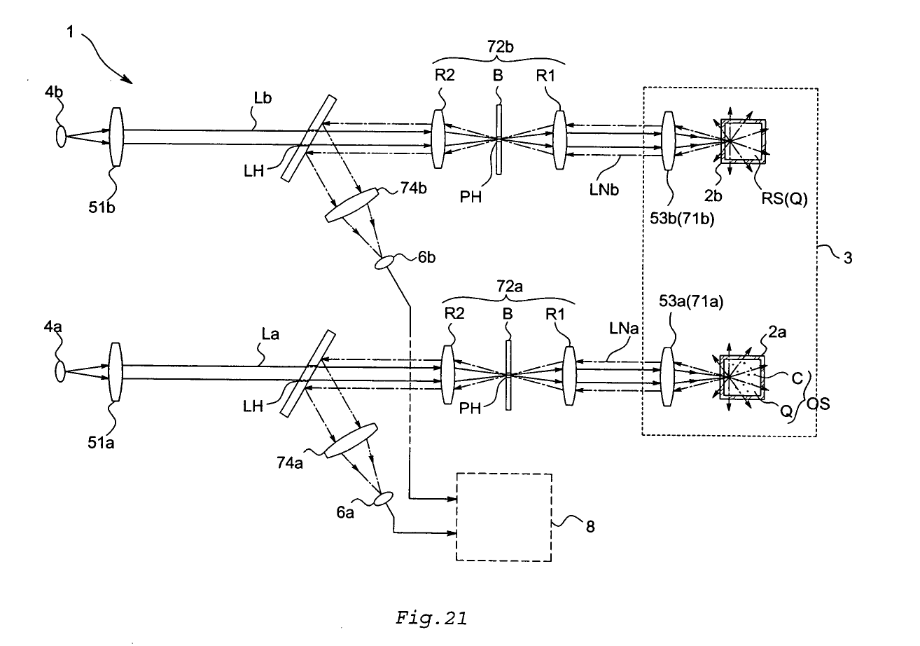

Also, it is possible to employ an arrangement wherein two independent light sources 4a and 4b are provided to form two completely independent measurement systems up to respective photodetectors 6a and 6b, as shown in FIG. 21.

Further possible arrangement is such that instead of dividing laser light L, the cells 2a and 2b are moved so that either of the cells 2a and 2b is selectively irradiated with laser light L. In such an arrangement, it is sufficient for the fundamental light guide mechanism and the scattering light guide mechanism to define only one optical path and, of course, a single light source and a single light intensity detecting section are sufficient. Further, such an arrangement is applicable not only to the aforementioned dynamic light scattering particle size distribution analyzer but also to the so-called light scattering/diffraction particle size distribution analyzer which analyzes a particle size distribution from an angle distribution of scattering light intensity.

It is needless to say that the shape of each of the cells is not limited to a rectangular parallelepiped and may be a cylindrical shape. The focal point of laser light L may be in the center of each cell or on another point. If possible, the aforementioned arrangements may be combined variously.

According to the present invention having been described in detail, it is possible to irradiate the reference cell and the sample cell with fundamental light and measure scattering lights from the respective samples in substantially the same time zone. Therefore, disturbing influence from the same factor arising during measurement, namely noise, can be cancelled by deduction of the difference between the results of measurement on the scattering lights and, hence, only the information on the scattering light from a group of test particles can be extracted effectively.

While only certain presently preferred embodiments of the present invention have been described in detail, as will be apparent for those skilled in the art, certain changes and modifications may be made in embodiments without departing from the spirit and scope of the present invention as defined by the following claims.

1. A particle size distribution analyzer for analyzing a particle size distribution of a group of particles contained in a sample based on a fluctuation of scattering light caused by irradiating the sample with fundamental light, the particle size distribution analyzer comprising:
a reference cell for containing a reference sample used as a reference;
a test cell for containing a test sample composed of the reference sample and a group of test particles added thereto;
a fundamental light guide mechanism operative to divide fundamental light irradiated from a single light source and then guide divided fundamental lights to the reference sample and the test sample, respectively;
a scattering light guide mechanism operative to guide scattering lights caused by irradiation of the samples with the respective divided fundamental lights to a light intensity detecting section configured to detect the intensity of light; and
an information processing section for calculating a particle size distribution of the group of test particles contained in the test sample based either on a difference between fluctuations of the intensities of the respective scattering lights detected by the light intensity detecting section or on a difference between information items computed from the respective fluctuations.

2. The particle size distribution analyzer according to claim 1, wherein the reference sample is composed only of a predetermined solvent, while the test sample contains the test particles dispersed in the predetermined solvent.

3. The particle size distribution analyzer according to claim 1, wherein the fundamental light guide mechanism is composed of constituent elements including optical components, all the constituent elements being fixed, a light dividing element of the constituent elements being operative to divide the fundamental light spatially.

4. The particle size distribution analyzer according to claim 3, wherein the light dividing element is a half mirror disposed on the optical path of the fundamental light.

5. The particle size distribution analyzer according to claim 3, wherein the light dividing element is a pair of knife-edge mirrors disposed on the optical path of the fundamental light.

6. The particle size distribution analyzer according to claim 1, wherein the fundamental light guide mechanism is composed of constituent elements including optical components, some of the constituent elements being movable, for guiding the fundamental light to either of the samples selectively by moving the movable elements.

7. The particle size distribution analyzer according to claim 1, wherein the cells are formed integral with each other.

8. A particle size distribution analyzer for analyzing a particle size distribution of a group of particles contained in a sample based on a fluctuation of scattering light caused by irradiating the sample with fundamental light, the particle size distribution analyzer comprising:
a reference cell for containing a reference sample;
a test cell for containing a test sample containing a group of test particles dispersed in the predetermined solvent;
a fundamental light guide mechanism operative to guide fundamental light irradiated from a single light source to the reference sample and then further guide the fundamental light having passed through the reference sample to the test sample;
a scattering light guide mechanism operative to guide scattering lights from the respective samples to a light intensity detecting section configured to detect the intensity of light; and
an information processing section for calculating a particle size distribution of the group of test particles contained in the test sample based either on a difference between fluctuations of the intensities of the respective scattering lights detected by the light intensity detecting section or on a difference between information items computed from the respective fluctuations.

9. A particle size distribution analyzer for analyzing a particle size distribution of a group of particles contained in a sample based on a fluctuation of scattering light caused by irradiating the sample with fundamental light, the particle size distribution analyzer comprising:
a reference cell for containing a reference sample used as a reference;
a test cell for containing a test sample composed of the reference sample and a group of test particles added thereto;
a fundamental light guide mechanism operative to guide one of fundamental lights irradiated from a pair of light sources to the reference sample and the other to the test sample;
a scattering light guide mechanism operative to guide scattering lights from the respective samples to a light intensity detecting section configured to detect the intensity of light; and
an information processing section for calculating a particle size distribution of the group of test particles contained in the test sample based either on a difference between fluctuations of the intensities of the respective scattering lights detected by the light intensity detecting section or on a difference between information items computed from the respective fluctuations.

10. The particle size distribution analyzer according to claim 1, wherein a pair of light intensity detecting sections are provided and the scattering light guide mechanism is operative to guide scattering lights from the respective samples to the respective light intensity detecting sections.

11. The particle size distribution analyzer according to claim 8, wherein a pair of light intensity detecting sections are provided and the scattering light guide mechanism is operative to guide scattering lights from the respective samples to the respective light intensity detecting sections.

12. The particle size distribution analyzer according to claim 9, wherein a pair of light intensity detecting sections are provided and the scattering light guide mechanism is operative to guide scattering lights from the respective samples to the respective light intensity detecting sections.

13. The particle size distribution analyzer according to claim 1, wherein a single light intensity detecting section is provided and the scattering light guide mechanism is operative to switch from one of scattering lights from the respective samples to the other for selectively guiding either of the scattering lights to the light intensity detecting section.

14. The particle size distribution analyzer according to claim 8, wherein a single light intensity detecting section is provided and the scattering light guide mechanism is operative to switch from one of scattering lights from the respective samples to the other for selectively guiding either of the scattering lights to the light intensity detecting section.

15. The particle size distribution analyzer according to claim 9, wherein a single light intensity detecting section is provided and the scattering light guide mechanism is operative to switch from one of scattering lights from the respective samples to the other for selectively guiding either of the scattering lights to the light intensity detecting section.

16. A particle size distribution analyzer for analyzing a particle size distribution of a group of particles contained in a sample based on a fluctuation of scattering light caused by irradiating the sample with fundamental light, the particle size distribution analyzer comprising:
a reference cell for containing a reference sample used as a reference;
a test cell for containing a test sample composed of the reference sample and a group of test particles added thereto;
a fundamental light guide mechanism operative to guide fundamental light irradiated from a light source to a predetermined irradiation region;
a cell moving mechanism operative to selectively move the reference cell or the test cell to the irradiation region;
a scattering light guide mechanism operative to guide scattering light from one of the samples which is positioned in the irradiation region to a light intensity detecting section configured to detect the intensity of light; and
an information processing section for calculating a particle size distribution of the group of test particles contained in the test sample based on a difference between information items related to the intensities of respective scattering lights detected by the light intensity detecting section.

17. The particle size distribution analyzer according to claim 16, wherein the information items related to the intensities of respective scattering lights are information items on angle distributions of the intensities of the respective scattering lights.

18. A particle size distribution analyzer for analyzing a distribution of particles in a sample from an interaction with light, comprising:
a source of light for providing a light beam;
a test cell for receiving the sample;
a reference cell for replicating predetermined characteristics of the test cell;
a detector assembly for monitoring respectively an interaction of the light beam, with the test cell and the reference cell and providing corresponding test cell output signals and reference cell output signals; and
a control unit for processing the output signals by comparing the test cell output signals and the reference cell output signals and calculating a particle size distribution based on the difference between the respective output signals.

19. The particle size distribution analyzer of claim 18 further including an optical guide mechanism for directing all or a portion of the light beam to the test cell and the reference cell.
